(19) United States
(12) Patent Application Publication
(10) Pub. No.: US 2005/0128314 A1
(43) Pub. Date: Jun. 16, 2005

(54) Image-taking apparatus and image-taking system

(75) Inventor: Toshiki Ishino, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/002,905

(22) Filed: Dec. 3, 2004

(30) Foreign Application Priority Data
Dec. 10, 2003 (JP) 2003-412604

(51) Int. Cl. H04N 5/228

(52) U.S. Cl. 348/222.1

(57) ABSTRACT

An image-taking apparatus includes an image-pickup element having a plurality of pixels; a control section selectively performing a first image-taking operation using the image-pickup element or a second image-taking operation at a higher pixel number or a lower frame rate than for the first image-taking operation; and a detecting section detecting a state of an image-taking object. The control section performs the first image-taking operation when the state of the image-taking object detected by the detecting section is within a predetermined range, and performs the second image-taking operation when the state of the image-taking object detected by the detecting section is outside the predetermined range.

### BACKGROUND OF THE INVENTION

1. Field of the Invention

The present invention relates to image-taking apparatuses and image-taking systems which are capable of sending video images over a network, such as a LAN or the Internet.

2. Description of Related Art

In recent years, network cameras have been proposed which send images that have been taken with a camera via a communications network such as a LAN or the Internet to a surveillance terminal unit, such network cameras being used as a replacement for cameras storing video images on such media as tape or film. Cameras used as this kind of network cameras may be placed on busy streets, at locations where they cannot be reached by people, and the image data taken there may be sent via the communications network and displayed on a liquid crystal panel of a surveillance terminal unit.

Moreover, network cameras have been proposed which allow such operations as panning, tilting or zooming of a remote camera by operating a. remote control provided at the surveillance terminal unit. With this kind of network camera, it is possible to take pictures of the object under surveillance from an angle and at a zoom ratio that suites the preferences of the operator, and it is possible to observe the taken images on the liquid crystal panel of the surveillance terminal unit.

With present network cameras, the capacity of the communication line tends to the bottleneck, and the resolution is restricted to CIF (352×288) when taking moving pictures at 30 frames per second.

In recent years, the number of pixels of CCDs serving as the image-pickup elements is on the rise, and video cameras using CCDs with high pixel densities are used to take moving pictures at NTSC level as well as to take still pictures with high resolutions of XGA level or higher, using the pixels of the CCD to the full extent.

Moreover, also with network cameras, it has become possible to take moving pictures at 30 frames per second at CIF level as well as to take still pictures or moving pictures with low frame rates of one or two frames per second with high resolutions at XGA (1024×768) level.

A network camera with which images can be taken while switching the resolution between still pictures and moving pictures is disclosed in Japanese Patent Application Laid Open No. 2001-189932A.

The network camera disclosed in this publication has a change ratio detecting means for judging whether a change ratio per predetermined time of moving picture data of an object that is taken is equal to or greater than a predetermined value, and switches between taking still pictures and taking moving pictures based on the judgment result of this change ratio detecting means.

However, in this configuration, the change of the filmed object is judged based on the change of the image data of the taken images, so that it is not possible to detect a change in the filmed object that is related to heat, sound, current leaks or the like, which do not appear in the taken image. Therefore, the range of events which can be monitored is narrow, and the camera is insufficient as a surveillance camera.

### SUMMARY OF THE INVENTION

An image-taking apparatus according to one aspect of the present invention comprises an image-pickup element having a plurality of pixels; a control section selectively performing a first image-taking operation using the image-pickup element or a second image-taking operation at a higher pixel number or a lower frame rate than for the first image-taking operation; and a detecting section detecting a state of an image-taking object; wherein the control section performs the first image-taking operation when the state of the image-taking object detected by the detecting section is within a predetermined range, and performs the second image-taking operation when the state of the image-taking object detected by the detecting section is outside the predetermined range.

An image-taking apparatus according to another aspect of the present invention comprises an image-taking optical system; an image-pickup element having a plurality of pixels, the image-pickup element performing image-pickup through the image-taking optical system; a control section selectively performing a first image-taking operation using the image-pickup element or a second image-taking operation at a higher pixel number or a lower frame rate than for the first image-taking operation; and a detecting section detecting a state of the image-taking optical system; wherein the control section performs the first image-taking operation when the state of the image-taking optical system detected by the detecting section is within a predetermined range, and performs the second image-taking operation when the state of the image-taking optical system detected by the detecting section is outside the predetermined range.

These and further objects and features of the image-taking apparatus according to the present invention will become apparent from the following detailed description of preferred embodiments thereof taken in conjunction with the accompanying drawings.

### BRIEF DESCRIPTION OF THE DRAWINGS

FIG. 1 is a functional block diagram of an image-taking system according to any of Embodiments 1 to 5.

FIG. 2 is a diagrammatic view of Embodiment 1.

FIG. 3 is a flowchart showing the control procedure of a surveillance camera unit according to Embodiment 1.

FIG. 4 is a diagrammatic view of Embodiment 2.

FIG. 5 is a flowchart showing the control procedure of a surveillance camera unit according to Embodiment 2.

FIG. 6 is a diagrammatic view of Embodiment 3.

FIG. 7 is a flowchart showing the control procedure of a surveillance camera unit according to Embodiment 3.

FIG. 8 is a diagrammatic view of Embodiment 4.

FIG. 9 is a flowchart showing the control procedure of a surveillance camera unit according to Embodiment 4.

FIG. 10 is a diagrammatic View of Embodiment 5.

FIG. 11 is a flowchart showing the control procedure of a surveillance camera unit according to Embodiment 5.

### DESCRIPTION OF THE PREFERRED EMBODIMENTS

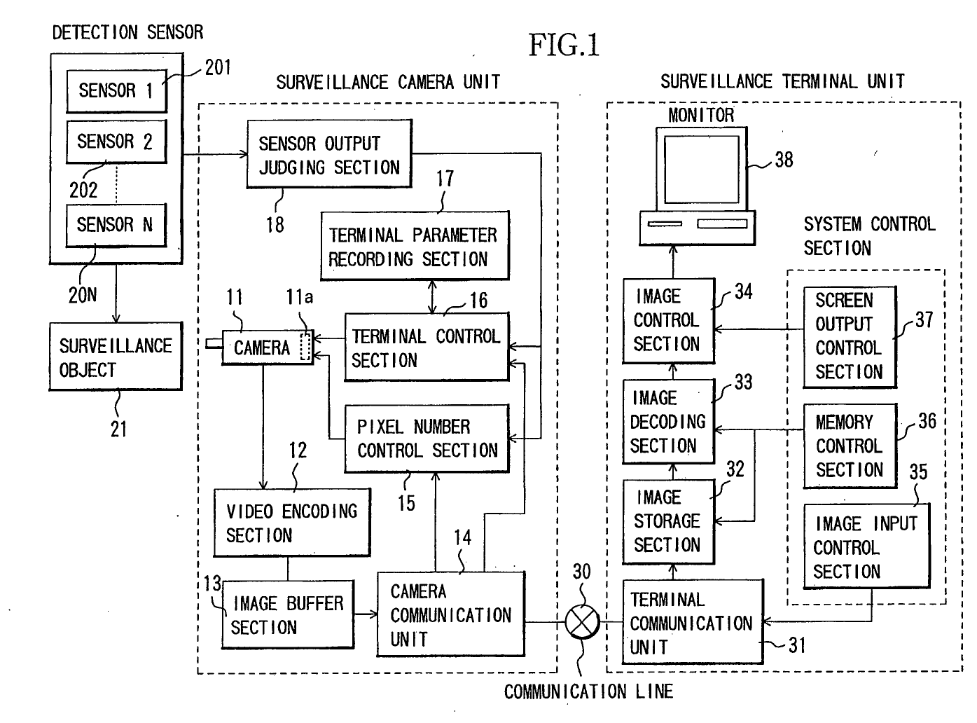

FIG. 1 is a block diagram showing the configuration of a network camera system according to an embodiment of the present invention. This network camera system is made of a surveillance camera unit taking images of an object under surveillance, and a surveillance camera unit connected via a communication line to this surveillance camera unit.

First, the configuration of the surveillance camera unit is explained. Reference numeral 11 denotes a camera, having pan and tilt mechanisms which change the image-taking direction and a zoom mechanism which changes the image-taking zoom ratio (not shown in the drawings).

Moreover, an image-pickup element 11a (for example a CCD sensor or a CMOS sensor) which photoelectrically converts light reflected from an object and outputs it as electric signals is built into the camera 11. In the present embodiment, it is preferable to use an image-pickup element with a high pixel number, in order to take high resolution images of the object under surveillance.

Here, if moving pictures are taken with the camera 11 at a high frame rate of 30 frames per second, then the image processing speed or the communication infrastructure may become a bottleneck, so that it is necessary to set the resolution of the taken images to CIF level (352×288).

Accordingly, in the present embodiment, when images are taken at a frame rate of 30 frames per second, then the resolution is set to CIF level, and when taking still pictures or when taking images at a low frame rate of one or two frames per second, then the pixels of the image-pickup element 11a are used in full, and image-taking with a resolution of at least XGA level (1024×768) is enabled.

Reference numeral 12 denotes an encoding section encoding the video images taken with the camera 11, and reference numeral 13 denotes an image buffer section for buffering the video images encoded by the encoding section 12.

Reference numeral 15 denotes a pixel number control section controlling the number of pixels read out from the image-pickup element 11a. The number of pixels read out from the image-pickup element 11a is changed depending on whether image-taking is performed at low resolution and high frame rate or whether image-taking is performed at high resolution and low frame rate. Reference numeral 16 denotes a terminal control section controlling driving of the camera 11 in the pan direction, driving in the tilt direction, as well as controlling the zoom ratio.

Reference numeral 14 denotes a camera communication unit connected via a communication line to the surveillance terminal unit. Reference numeral 17 denotes a terminal parameter recording section, in which favorable parameters for the pan, tilt and zooming operation of the camera 11 in accordance with the detection region of various sensors 201 to 20n are recorded.

Reference numeral 18 denotes a sensor output judging section outputting a predetermined signal to the terminal control section 16 and the pixel number control section 15, based on the signal output from the sensors 201 to 20n. Details of the sensor output judging section 18 are explained further below. Reference numeral 21 denotes a surveillance object that is surveilled by the sensors 201 to 20n.

The following is an explanation of the configuration of the surveillance terminal unit. Reference numeral 31 denotes a terminal communication unit that controls the communication with the surveillance camera unit. Reference numeral 32 denotes an image storage section recording image data sent from the camera communication unit 14 to the terminal communication unit 31.

Reference numeral 33 denotes an image decoding section decoding image data stored in the image storage section 32 into images. Reference numeral 34 denotes a screen control section displaying the images decoded by the image decoding section 33 on a monitor 38.

Reference numeral 35 denotes an image input control section, which is connected to the terminal communication unit 31 and which controls the pixel number control section 15 and the terminal control section 16 of the surveillance camera system via the communication line 30. Reference numeral 36 denotes a memory control section controlling, the image storage section 32 and the image decoding section 33, and reference numeral 37 denotes a screen output control section controlling the display state of the monitor 38.

The following is an explanation of the operation of this surveillance camera system. When the sensors 201 to 20n detect that the state of the surveillance object 21 has changed, then this detection result is output to the sensor output judging section 18, and it is judged whether the state of the surveillance object 21 is within a predetermined range. It should be noted that this predetermined range depends on the kind of the surveillance object 21 and the kind of the sensors 201 to 20n. Specific examples are given in the following Embodiments 1 to 5.

If. the state of the surveillance object 21 is outside the predetermined range, then a predetermined instruction signal is output by the sensor output judging section 18 to the terminal control section 16 and the pixel number control section 15, and the camera 11 is driven into a direction that is optimal for performing image-taking of the surveillance object 21.

Here, optimum parameters regarding the driving direction of the camera 11 corresponding to the number of the sensors are stored in the terminal parameter storage section 17. The terminal control section 16 reads out these parameters from the terminal parameter storage section 17 and drives the camera 11 accordingly. Thus, the camera 11 can be driven to the optimum position for image-taking of the surveillance object 21.

Moreover, when the pixel number control section 15 has received the above-mentioned instruction signal, it increases the pixel number read out from the image-pickup element 11a, and controls the camera 11 so as to allow image-taking at the CIF level. Thus, it is possible to take images of the surveillance object 21 at a high resolution when the state of the surveillance object 21 is outside the predetermined range.

The images taken with the camera 11 are encoded with the video encoding section 12 and buffered in the image buffer section 13. The image data buffered in the image buffer section 13 is sent from the camera communication unit 14 via the communication line 30 (which may be a LAN, a WAN or the Internet, for example) to the terminal communication unit 31, and stored in the image storage section 32.

The image data stored in the image storage section 32 is decoded by the image decoding section 33 into images, and is displayed by the screen control section 34 on the monitor 38.

Thus, an operator at the surveillance terminal unit can view the surveillance object 21 in detail on the monitor 38, when the state of the surveillance object 21 has left the predetermined range. Moreover, by operating an operating panel (not shown in the drawings) as necessary, the operator can change the parameters of the pixel number control section 15 and the terminal control section 16 by driving the image input control section 35. Thus, it is possible to take images in accordance with the operator's preferences.

Here, an action in which the operator operates the operation panel to set the zoom ratio of the camera 11 to the telephoto end indicates the operator's intention to obtain a more detailed image of the surveillance object 21. Therefore, in the present embodiment, the pixel number control section 15 is driven and the image-taking mode of the camera 11 is switched to high-resolution image-taking, in accordance with the action of setting the camera 11 to the telephoto end.

Embodiment 1

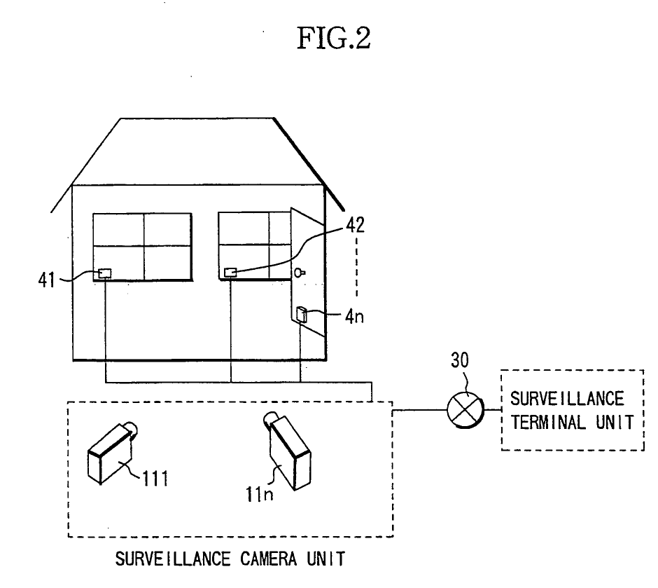

Using FIGS. 1 and 2, the following is an explanation of Embodiment 1 of the present invention. This embodiment relates to a surveillance camera system with the purpose of detecting intruders, in which vibration sensors are attached to the doors and windows of a house and detect whether the doors and windows are open or closed. If an applied vibration level exceeds a predetermined value, high-resolution image-taking is performed. FIG. 2 is a diagrammatic view showing how vibration sensors 41 to 4n are attached to the door and windows of a house. The internal configuration of the surveillance camera unit and the surveillance terminal unit are not shown in FIG. 2, with the exception of the cameras.

If the vibration level detected with any of the vibration sensors 41 to 41n is applied for more than a predetermined time or exceeds a predetermined level, then the sensor output judging section 18 judges that vibrations are applied because someone is trying to break into the house.

When the vibration sensor that has detected such a vibration is specified by the sensor output judging section 18, then the parameters for panning, tilting and zooming the cameras 11 that are most suitable for taking the area of the sensor that has detected the vibration are read out by the terminal control section 16 from the terminal parameter recording section 17, the pan and tilt position as well as the zoom ratio of the camera 11 are set in accordance with these parameters, and image-taking is performed at high resolution. The taken images are buffered in the image buffer section 13, and sent to the surveillance terminal unit in accordance with the operator's requests.

With this configuration, since a detailed image of the intruder trying to break into the house can be obtained by taking high-resolution images, it is possible to obtain incriminatory evidentiary images. Moreover, by sequentially buffering the video images taken at high resolution in the image buffer section 13, it is possible to confirm the temporal course of the events or incident.

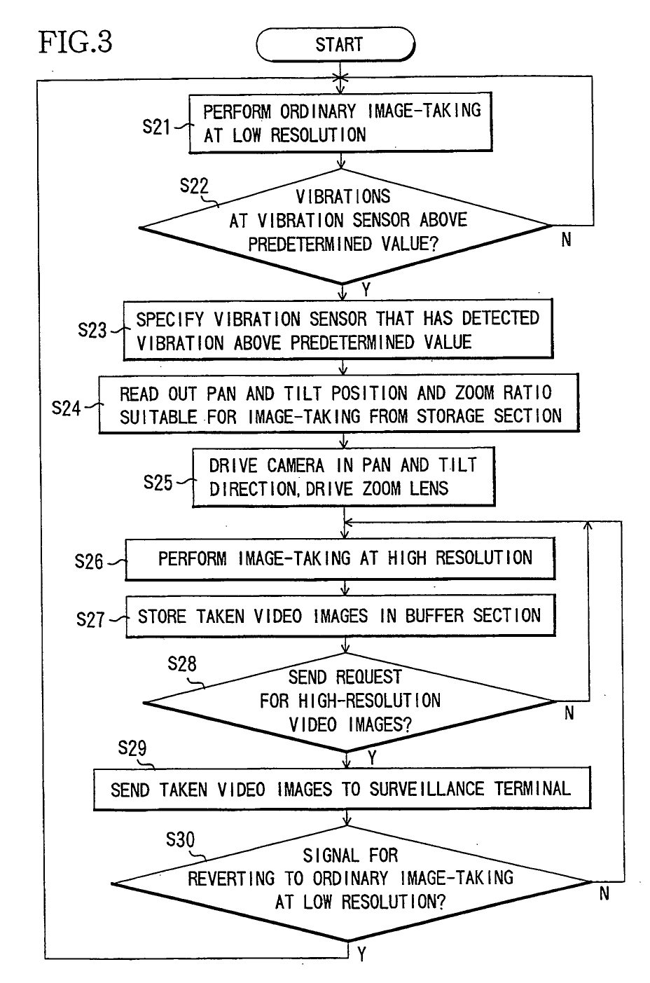

FIG. 3 is a flowchart showing the control procedure of the surveillance camera unit of the present embodiment. The procedure shown in the following flowchart is mainly executed by the terminal control section 16 and the pixel number control section 15.

When the vibration sensors 41 to 4n do not detect a vibration, moving pictures are taken at the ordinary low resolution (at a high frame rate of 30 frames per second) (Step 21).

When at least one of the vibration sensors 41 to 4n detects that a vibration is applied to one of the windows of the house, for example, then a signal is output from this vibration sensor. Based on this output signal, the sensor output judging section 18 judges whether the level of the detected vibrations or the time for which the vibrations carry on is above a predetermined value (Step 22). If it is not above a predetermined value, then image-taking with a low resolution is continued. In that case, the image-taking mode is not changed.

On the other hand, if the vibration level or the time for which the vibrations carry on is above a predetermined value, then the procedure advances to Step 23, and the vibration sensor that has detected the vibrations is specified. Then, at Step 24, the pan and tilt positions and the zoom ratio suitable for image-taking of the specified vibration sensor are read out from the terminal parameter recording section 17.

Then, at Step 25, the camera 11 is driven in the pan direction and the tilt direction in accordance with the values of the parameters read out from the terminal parameter recording section 17, and the zoom ratio is changed by moving a zoom lens (not shown in the drawings) built into the lens barrel of the camera 11.

When the image-taking conditions have been adjusted by these camera operations, high-resolution image-taking is performed using the camera 11. It should be noted that the resolution can be changed by controlling the number of pixels read out from the image-pickup element 11a as described above with the pixel number control section 15.

At Step 27, the images taken at high resolution are buffered as image data in the image buffer section 13. For how much time image data is buffered depends on the capacity of the image buffer section 13.

At Step 28, it is judged whether a request to send the images taken at high resolution has been issued by a surveillance terminal unit on the network. If there was a send request, then the image data of the images taken at high resolution is sent via the communication line 30 to the surveillance terminal unit.

With the above-described configuration, it is possible to alleviate the traffic on the network, because high-resolution images are sent only if there was a send request for them.

Even if there is no send request, high-resolution image-taking is continued, and the high-resolution images are buffered in the image buffer section 13, so that it is possible to provide them in the event of further requests for the sending of high-resolution images from the surveillance terminal unit.

At Step 30, it is detected whether a signal has been entered which instructs the surveillance camera unit to stop high-resolution image-taking and revert to ordinary image-taking. If a signal instructing the surveillance camera unit to stop high-resolution image-taking and revert to ordinary image-taking has been entered from the surveillance terminal unit, then the procedure returns to Step 21, and the image-taking mode is switched to ordinary image-taking at low resolution and high frame rate.

Embodiment 2

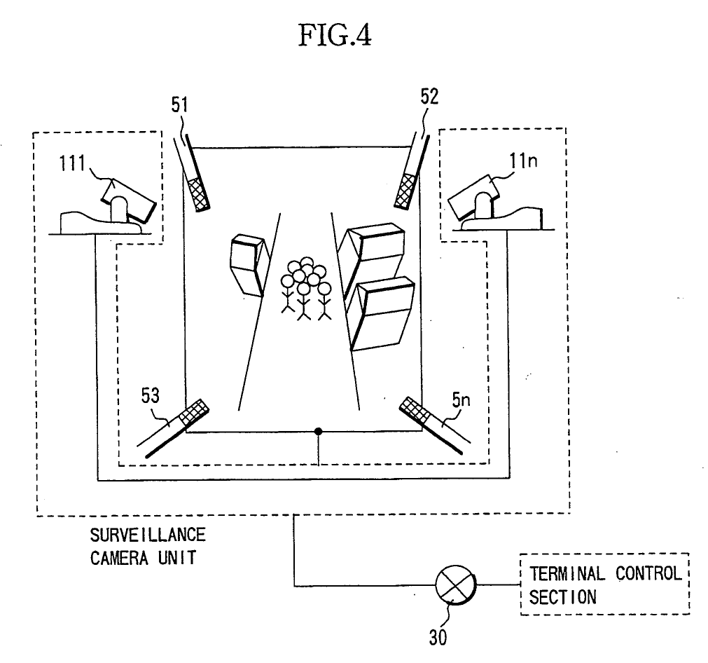

Referring to FIGS. 1 and 4, the following is an explanation of Embodiment 2 of the present invention.

In Embodiment 2, a plurality of microphones 51 to 5n (detecting means) are placed in a street, and high-resolution image-taking is performed if a sound level exceeds a predetermined value. FIG. 4 is a diagrammatic view showing how a plurality of cameras are arranged on a street, such as a busy main street, and images of the street are taken. The microphones 51 to 5n have directionality, and the sound from a plurality of directions can be picked up using the plurality of microphones.

The sensor output judging section 18 judges whether the sound level of the sound that is picked up with the microphones 51 to 5n exceeds a predetermined value. If the sound level exceeds a predetermined value, then the sensor output judging section 18 judges from which direction the sound comes. It is possible to specify the direction of the sound if there are at least two directional microphones. When the direction of the sound is specified, the cameras 11 are driven to positions corresponding to this specified direction, and high-resolution image-taking can be performed while pointing the image-taking lens into the direction from which the sound is emitted. The taken images are recorded in the image buffer section 13.

Thus, by taking the location from which sound of at least a predetermined sound level is emitted at a high resolution, it is possible to examine the cause of the sound (for example a traffic accident or other incident) in detail. Also, the images taken at high resolution are successively buffered in the image buffer section 13, so that by reading out and confirming the buffered images, it is possible to accurately assess the course of the accident or incident.

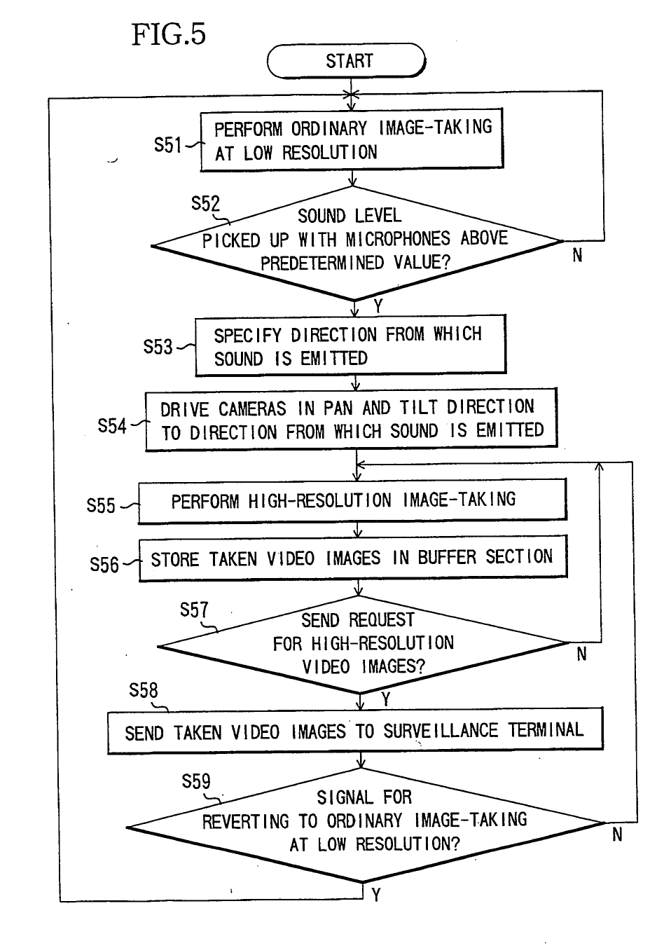

FIG. 5 is a flowchart showing the control procedure of the surveillance camera unit of the present embodiment. The following flowchart is executed mainly by the structural elements of the surveillance camera unit in FIG. 1.

At Step 51, image-taking is performed at the ordinary low resolution and at a high frame rate of 30 frames per second. The sensor output judging section 18 judges whether the sound level of the sound that is picked up by the microphones 51 to 5n exceeds a predetermined value, and if it does exceed a predetermined value, then the procedure advances to Step 52, whereas if it does not exceed a predetermined value, then low-resolution image-taking is continued, and there is no particular change of the image-taking mode.

At Step 53, the direction of the sound emitted at more than a predetermined value is specified by the sensor output judging section 18. At Step 54, the cameras 11a to 11n are driven towards the direction of the sound specified at Step 53, and at Step 55, high-resolution image-taking is performed. As in Embodiment 1, high-resolution image-taking is performed by driving the pixel number control section 15 and increasing the number of pixels read out from the image-pickup element 11a.

At Step 56, the images taken at high resolution are buffered as image data in the image buffer section 13. For how much time image data is buffered depends on the capacity of the image buffer section 13. At Step 57, it is judged whether a request to send the images taken at high resolution has been issued by the surveillance terminal unit on the network.

If there was a send request for the images taken at high resolution, then, at Step 58, the images taken at high resolution are sent to the surveillance terminal unit. With the above-described configuration, it is possible to alleviate the traffic on the network, because high-resolution images are sent only if there was a send request for them.

Even if there is no send request from the surveillance terminal unit, high-resolution image-taking is continued, and the high-resolution images are buffered in the image buffer section 13, so that it is possible to provide them in the event of further requests for the sending of high-resolution images from the surveillance terminal unit.

At Step 59, it is judged whether a signal has been entered which instructs the surveillance camera unit to stop high-resolution image-taking and revert to ordinary image-taking.

If a signal instructing the surveillance camera unit to revert to ordinary image-taking has been entered from the surveillance terminal unit, then the procedure returns to Step 51, and the image-taking mode is switched to ordinary image-taking at low resolution and high frame rate.

Embodiment 3

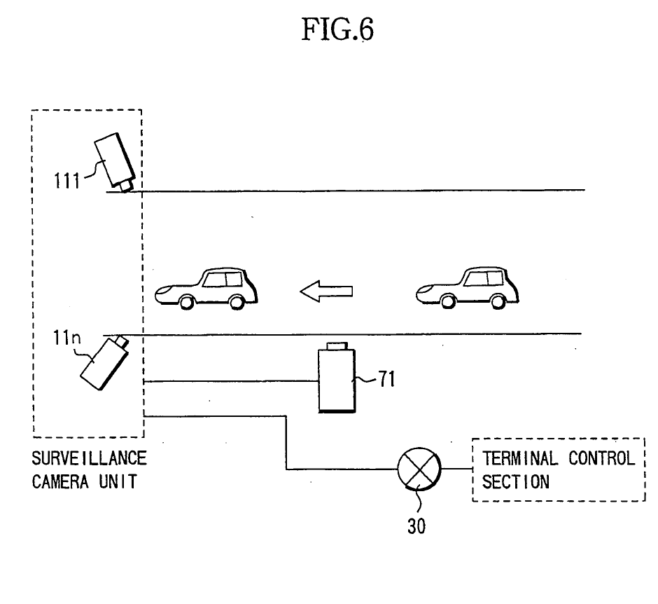

Referring to FIGS. 1 and 6, the following is an explanation of Embodiment 3. Embodiment 3 relates to an image-taking apparatus for the purpose of monitoring the speed of vehicles, in which a speed sensor detecting the speed of vehicles is disposed beside a roadway. If the speed of a vehicle exceeds a predetermined speed, then high-resolution video images are automatically taken, which is useful to identify the vehicle holder. FIG. 6 is a diagrammatic view showing how the speed sensor for detecting vehicle speed is arranged beside the roadway and how it detects the speed of vehicles driving by.

When the sensor output Judging section 18 judges that the speed of a vehicle detected by the speed sensor 71 exceeds a predetermined speed, then the cameras 11a to 11n automatically take high-resolution video images of the vehicle driving at excessive speed. The taken video images are buffered as video data in the image buffer section 13.

Thus, by taking high-resolution images of vehicles driving at excessive speed, it is possible to obtain detailed image data showing, for example, the number plate of the vehicle or the face of the driver, so that it is easy to identify the offending vehicle or the offending driver. Moreover, the video images taken at high resolution are successively buffered in the image buffer section 13, so that it is possible to later confirm the course of an accident or incident.

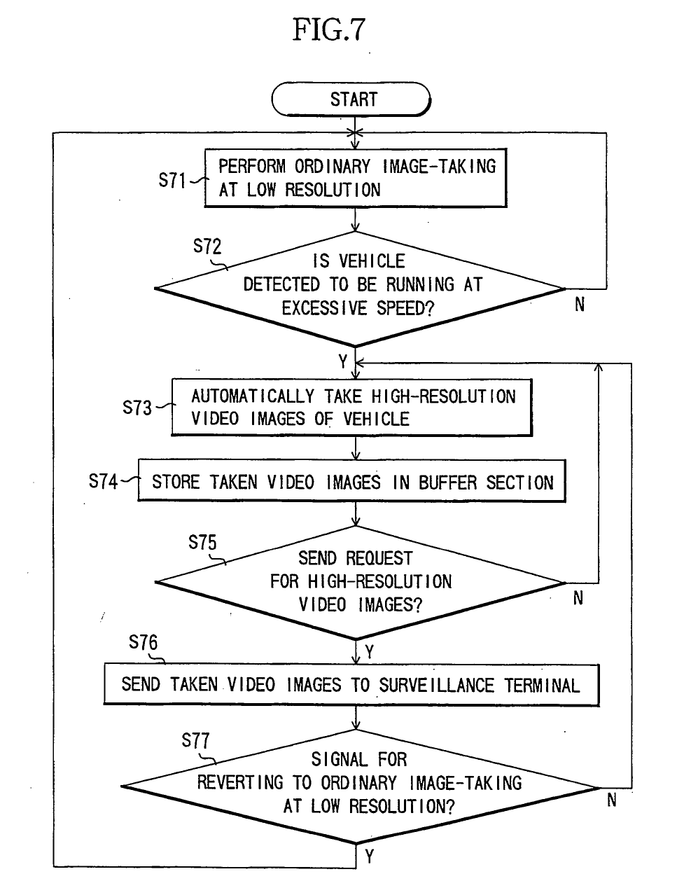

FIG. 7 is a flowchart showing the control procedure of the surveillance camera unit of the present embodiment. The procedure of the following flowchart is executed by the structural elements of the surveillance camera unit in FIG. 1.

At Step 71, image-taking is performed at the ordinary low resolution and at a high frame rate of 30 frames per second. At Step 72, the sensor output judging section 18 judges whether the speed of the vehicle detected with the speed sensor 71 exceeds a predetermined speed. If the speed exceeds the predetermined speed, then the procedure advances to Step 73, and images of the speeding vehicle are taken at high resolution.

As in Embodiment 1, high-resolution image-taking is performed by driving the pixel number control section 15 and increasing the number of pixels read out from the image-pickup element 11a. If no speeding vehicle is detected, then the ordinary low-resolution image-taking is continued and there is no particular change in the image-taking mode.

At Step 74, the images of the vehicle taken at high resolution are buffered as image data in the image buffer section 13. For how much time image data is buffered depends on the capacity of the image buffer section 13.

At Step 75, it is judged whether a request to send the video images taken at high resolution has been issued by the surveillance terminal unit on the network. At Step 75, if there was a send request from the surveillance terminal unit for the video images taken at high resolution, then the video images taken at high resolution are sent to the surveillance terminal unit at Step 76.

With the above-described configuration, it is possible to alleviate the traffic on the network, because high-resolution images are sent only if there was a send request for them. Even if there is no send request from the surveillance terminal unit, high-resolution image-taking is continued, and the high-resolution images are buffered in the image buffer section 13, so that it is possible to provide them in the event of further requests for the sending of high-resolution images from the surveillance terminal unit.

At Step 77, it is detected whether a signal has been entered which instructs the surveillance camera unit to stop high-resolution image-taking and revert to ordinary image-taking. If a signal instructing the surveillance camera unit to revert to ordinary image-taking has been entered, then the procedure returns to Step 71, and the image-taking mode is switched to ordinary image-taking at low resolution and high frame rate.

In the present embodiment, the sensor output judging section 18 judges whether the speed of vehicles exceeds a predetermined speed, but it is also possible to let the sensor output judging section 18 judge whether the speed of vehicles is below a predetermined speed and thus monitor the traffic for traffic jams.

It is also possible to arrange cameras and speed sensors along a carry path of containers on a conveyor, and let the sensor output judging section 18 judge whether the carry speed of the containers is below a predetermined value. Thus, when the carry speed is slow, it is possible to take high-resolution images of the containers, and to accurately monitor for jamming of the containers.

Embodiment 4

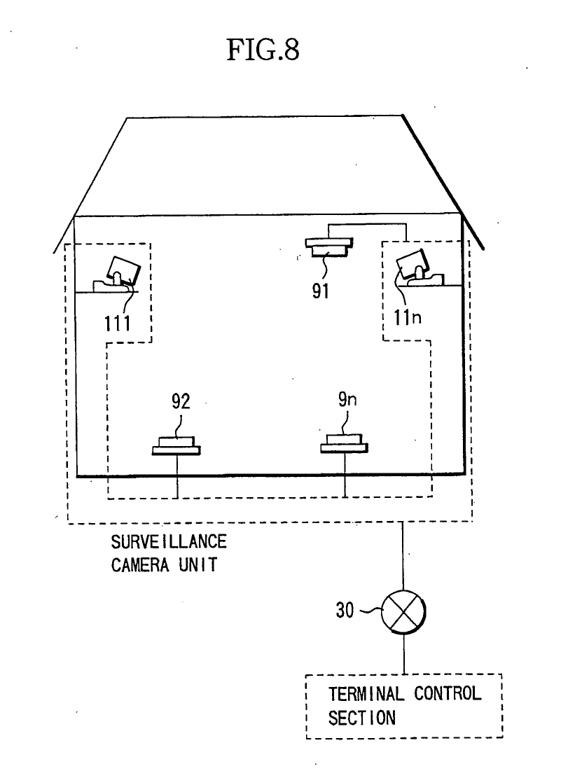

Referring to FIGS. 1 and 8, the following is an explanation of Embodiment 4 of the present invention. This Embodiment 4 relates to an image-taking apparatus for the purpose of preventing fires, in which temperature sensors are placed at locations that are prone to catch on fire, such as a kitchen or the like, and high-resolution image-taking is performed if the detected temperature reaches at least a predetermined value.

FIG. 8 is a diagrammatic view showing the arrangement of a plurality of temperature sensors 91 to 9n at locations within a kitchen that tend to be the cause for fires, as well as the arrangement of cameras 11a to 11n for taking these locations. If the sensor output judging section 18 judges that at least one of the temperatures detected by the temperature sensors 91 to 9n exceeds a predetermined temperature, then the cameras 11a to 11n point their image-taking lenses toward the temperature sensor which has detected the heightened temperature, and high-resolution video images are automatically obtained.

The pan and tilt direction of the image-taking lenses as well as the zoom ratio are set by reading out parameters correlating the positions at which the temperature sensors 91 to 9n are arranged and the driving directions of the image-taking lenses from the terminal parameter recording section 17.

By automatically obtaining high-resolution video images of high-temperature locations, it is possible to specify locations at which a fire has not yet occurred but which are at a heightened temperature, and to observe these locations closely, so that it is possible to prevent fires before they occur.

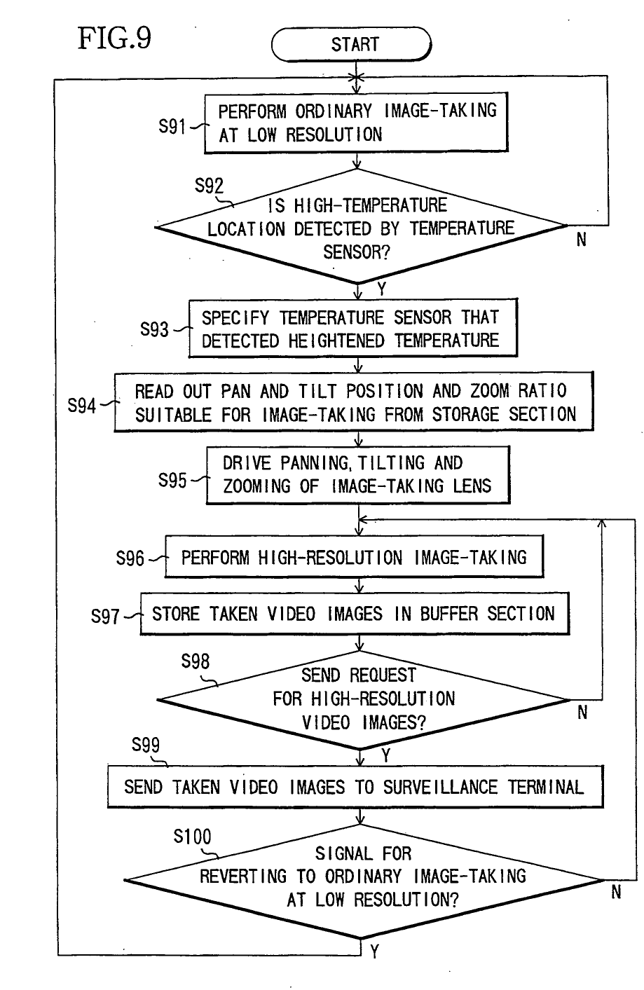

FIG. 9 is a flowchart showing the control procedure of the surveillance camera unit of the present embodiment. The procedure of the following flowchart is executed by the structural elements of the surveillance camera unit in FIG. 1.

At Step 91, image-taking is performed at the ordinary low resolution and at a high frame rate of 30 frames per second. At Step 92, the sensor output judging section 18 judges whether the temperature detected by the temperature sensors 91 to 9n exceeds a predetermined temperature. If there is an excessive temperature, then the procedure advances to Step 93, and it is specified which of the temperature sensors 11a to 11n has detected the heightened temperature.

If there is no particular location at which a heightened temperature is detected, then the ordinary low-resolution image-taking is continued and there is no particular change in the image-taking mode.

At Step 94, the parameters for panning, tilting and zooming that are most suitable for taking the area that is the cause of the temperature detected by the temperature sensor (i.e. the vicinity of that temperature sensor) is read out from the terminal parameter recording section 17. Then, the procedure advances to Step 95, and the cameras 11a to 11n are driven to the optimum image-taking position in accordance with the parameters read out from the terminal parameter recording section 17.

At Step 96, images are taken at high resolution with the cameras 11a to 11n which have been driven to the optimum image-taking positions. The high-resolution image-taking is performed by driving the pixel number control section 15 as described above and increasing the number of pixels read out from the image-pickup element 11a.

At Step 97, the video image data taken at high resolution is buffered as image data in the image buffer section 13. For how much time image data is buffered depends on the capacity of the image buffer section 13.

At Step 98, it is judged whether a request to send the video images taken at high resolution has been issued by the surveillance terminal unit on the network.

If there was such a send request, then, at Step 99, the video images taken at high resolution are sent to the surveillance terminal unit. With the above-described configuration, it is possible to alleviate the traffic on the network, because high-resolution video images are sent only if there was a send request for them.

Even if there is no send request from the surveillance terminal unit, high-resolution image-taking is continued, and the high-resolution images are buffered in the image buffer section 13, so that it is possible to provide them in the event of further requests for the sending of high-resolution images from the surveillance terminal unit.

At Step 100, it is detected whether a stop signal instructing the surveillance camera unit to stop high-resolution image-taking has been entered. If a signal instructing the surveillance camera unit to stop high-resolution image-taking and to revert to ordinary image-taking has been entered from the surveillance terminal unit, then the procedure returns to Step 91, and the image-taking mode is switched to ordinary image-taking at low resolution and high frame rate.

Embodiment 5

Referring to FIGS. 1, 10 and 11, the following is an explanation of Embodiment 5 of the present invention. This embodiment relates to an image-taking apparatus for the purpose of crime prevention and taking evidentiary video images, in which a switch is provided at the door of an office or the like to detect when the door is opened or closed. When it is detected with this switch that the door is opened, high-resolution video images are taken automatically.

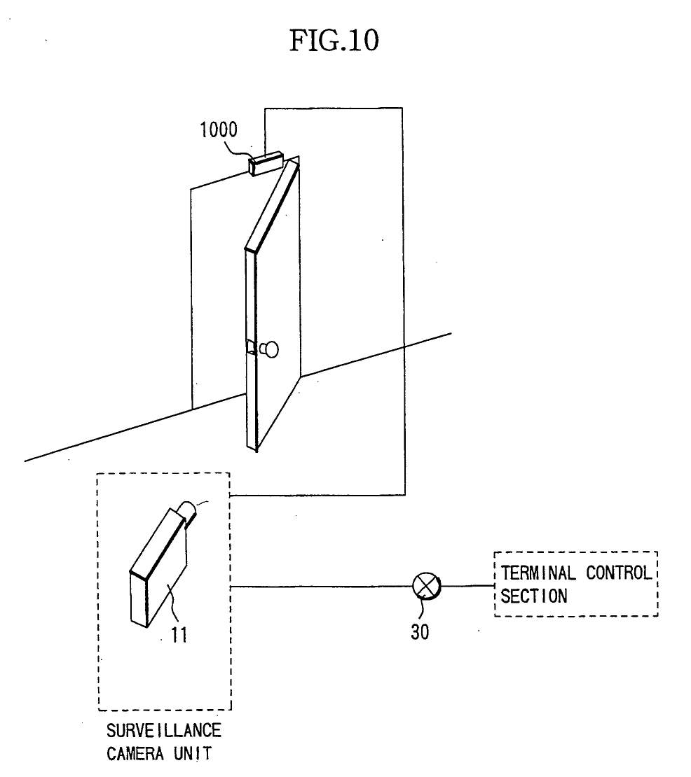

FIG. 10 is a diagrammatic view showing how an office door is provided with a switch detecting when the door is opened or closed as well as the arrangement of a camera 11 taking images of the area around the door. The camera 11 is arranged at a position where it is possible to take images of the face of an intruder opening the door and trying to enter the office. It should be noted that the intruder may be aware of the fact that the camera 11 is set up, which may also serve as a deterrent to crime. Moreover, high-resolution images can serve as evidence in the case that a burglary or the like has been committed.

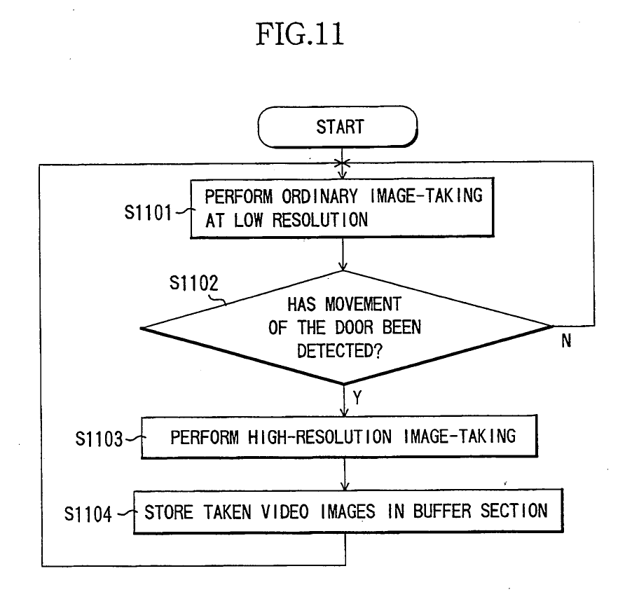

FIG. 11 is a flowchart showing the control procedure of the surveillance camera unit of the present embodiment. The procedure of the following flowchart is executed by the structural elements of the surveillance camera unit in FIG. 1.

At Step 1101, image-taking is performed at the ordinary low resolution and at a high frame rate of 30 frames per second. At Step 1102, the sensor output judging section 18 judges, based on a possible displacement of the door detected by the switch 1000, whether the door is open or closed.

If it is judged that the door has been opened, then it is judged that an intruder has entered the office, and the procedure advances to Step 1103.

At Step 1103, the surveillance camera unit is driven and high-resolution video images of the intruder's face are automatically taken. As described above, the high-resolution image-taking is performed by driving the pixel number control section 15 so that the number of pixels read out from the image-pickup element 11a is high.

At Step 1104, the video images of the intruder's face taken at high resolution are buffered in the image buffer section 13. The high-resolution video images buffered in the image buffer section 13 are sent to the surveillance terminal unit only when there is a send request from the surveillance terminal unit. With this configuration, it is possible to alleviate the traffic on the network and to protect the privacy of individuals.

When the high-resolution image-taking has finished, the procedure returns to Step 1101, and the image-taking mode switches again to low resolution and high frame rate.

While preferred embodiment(s) have been described, it is to be understood that modification and variation of the present invention may be made without departing from the scope of the following claims.

“This application claims priority from Japanese Patent Application No. 2003-412604 filed on Dec. 10, 2003, which is hereby incorporated by reference herein.”

1. An image-taking apparatus, comprising:
an image-pickup element having a plurality of pixels;
a control section selectively performing a first image-taking operation using the image-pickup element or a second image-taking operation at a higher pixel number or a lower frame rate than for the first image-taking operation; and
a detecting section detecting a state of an image-taking object;
wherein the control section performs the first image-taking operation when the state of the image-taking object detected by the detecting section Is within a predetermined range, and performs the second image-taking operation when the state of the image-taking object detected by the detecting section is outside the predetermined range.

2. The image-taking apparatus according to claim 1,
wherein the detecting section detects the state of the image-taking object independently from an image signal obtained with the image-pickup element.

3. The image-taking apparatus according to claim 1,
wherein the image-taking apparatus comprises a plurality of detecting sections, which are arranged at different locations;
wherein an image-taking range of the image-pickup element can be changed; and
wherein the control section performs the second image-taking operation with regard to the image-taking range corresponding to a position of any of the plurality of detecting sections detecting that the state of the image-taking object is outside the predetermined range.

4. The image-taking apparatus according to claim 1,
wherein the detecting section detects vibrations; and
wherein the control section performs the second image-taking operation when the detecting section has detected a vibration whose size is outside of a predetermined range or a vibration that lasts for at least a predetermined time.

5. The image-taking apparatus according to claim 1,
wherein the detecting section detects sound; and
wherein the control section performs the second image-taking operation when the detecting section has detected a sound whose volume is outside the predetermined range or a sound that lasts for at least a predetermined time.

6. The image-taking apparatus according to claim 1,
wherein the detecting section detects a speed of a moving object; and
wherein the control section performs the second image-taking operation when the detecting section has detected a speed that is outside the predetermined range.

7. The image-taking apparatus according to claim 1,
wherein the detecting section detects a temperature; and
wherein the control section performs the second image-taking operation when the detecting section has detected a temperature that is outside the predetermined range.

8. The image-taking apparatus according to claim 1,
wherein the detecting section detects a displacement of an object; and
wherein the control section performs the second image-taking operation when the detecting section has detected a displacement that is outside the predetermined range.

9. The image-taking apparatus according to claim 1,
further comprising a sending section which sends, over a network, image information obtained with the image-pickup element.

10. An image-taking apparatus, comprising:
an image-taking optical system;
an image-pickup element having a plurality of pixels, the image-pickup element performing image-pickup through the image-taking optical system;
a control section selectively performing a first image-taking operation using the image-pickup element or a second image-taking operation at a higher pixel number or a lower frame rate than for the first image-taking operation; and
a detecting section detecting a state of the image-taking optical system;
wherein the control section performs the first image-taking operation when the state of the image-taking optical system detected by the detecting section is within a predetermined range, and performs the second image-taking operation when the state of the image-taking optical system detected by the detecting section is outside the predetermined range.

11. The image-taking apparatus according to claim 10,
wherein the detecting section detects a zoom state of the image-taking optical system;
wherein the control section performs the second image-taking operation when the detecting section has detected a zoom state that is further to the telephoto end a predetermined zoom range.

12. The image-taking apparatus according to claim 10,
further comprising a sending section which sends, over a network, image information obtained with the image-pickup element.

13. An image-taking system, comprising:.
the image-taking apparatus according to claim 9; and
a control apparatus controlling the image-taking apparatus over the network and receiving the image information sent by the image-taking apparatus over the network.

14. An image-taking system, comprising:
the image-taking apparatus according to claim 12; and
a control apparatus controlling the image-taking apparatus over the network and receiving the image information sent by the image-taking apparatus over the network.
